(19) United States
(12) Patent Application Publication
(10) Pub. No.: US 2019/0266945 A1
(43) Pub. Date: Aug. 29, 2019

(54) DISPLAY DEVICE

(71) Applicant: InnoLux Corporation, Miao-Li County (TW)

(72) Inventors: Li-Jin WANG, Miao-Li County (TW); Yao-Lien HSIEH, Miao-Li County (TW)

(21) Appl. No.: 16/260,682

(22) Filed: Jan. 29, 2019

(30) Foreign Application Priority Data
Feb. 23, 2018 (CN) 201810154763.X

(51) Int. Cl. G09G 3/3233; G02F 1/1343; G09G 3/3275; G09G 3/36; G09G 3/3266

(52) U.S. Cl. CPC G09G 3/3233; G02F 1/1343; G09G 3/3266; G09G 3/3659; G09G 3/3685; G09G 3/3275

(57) ABSTRACT

A display device is disclosed, which includes: a substrate; a first pixel and a second pixel disposed on the substrate and arranged along a first direction; and a first data line and a second data line disposed on the substrate and arranged along a second direction different from the first direction, and the first and second pixels are disposed between the first and second data lines, wherein the first data line is electrically connected to the first pixel, the second data line is electrically connected to the second pixel, a first conductive portion of the first data line is electrically connected to a second conductive portion of the first data line through a first conductive via, and a first conductive portion of the second data line is electrically connected to a second conductive portion of the second data line through a second conductive via.

### CROSS REFERENCE TO RELATED APPLICATION

This application claims the benefits of the Chinese Patent Application Serial Number 201810154763.X, filed on Feb. 23, 2018, the subject matter of which is incorporated herein by reference.

### BACKGROUND

### 1. Field

The present disclosure relates to a display device. More specifically, the present disclosure relates to a display device with higher aperture ratio.

### 2. Description of Related Art

With the continuous advancement of technologies related to display devices, the display devices are developed toward small size, compactness, thinness or lightness. The thin display devices are developed for many years; manufactures still intend to increase the resolution of the display. However, the display devices with high resolutions have the problem of low aperture ratios. Therefore, it is desirable to provide a display device with higher aperture ratios to satisfy the requirements of high resolution.

### SUMMARY

An object of the present disclosure is to provide a display device, which comprises: a substrate; a first pixel and a second pixel disposed on the substrate, wherein the first pixel and the second pixel are arranged along a first direction; and a first data line and a second data line disposed on the substrate, wherein the first data line and the second data line are arranged along a second direction, the first pixel and the second pixel are disposed between the first data line and the second data line, and the first direction is different from the second direction. Herein, the first data line is electrically connected to the first pixel, the second data line is electrically connected to the second pixel, a first conductive portion of the first data line is electrically connected to a second conductive portion of the first data line through a first conductive via, and a first conductive portion of the second data line is electrically connected to a second conductive portion of the second data line through a second conductive via.

The present disclosure also provides a display device, which comprises: a substrate; a first pixel and a second pixel disposed on the substrate, wherein the first pixel and the second pixel are arranged along a first direction; and a first scan line and a second scan line disposed on the substrate, wherein the first scan line and the second scan line are arranged along a first direction, wherein the first scan line is electrically connected to the first pixel, the second scan line is electrically connected to the second pixel, and a first conductive portion of the first scan line is electrically connected to a second conductive portion of the first scan line through a conductive via.

Other novel features of the disclosure will become more apparent from the following detailed description when taken in conjunction with the accompanying drawings.

### BRIEF DESCRIPTION OF THE DRAWINGS

FIG. 1 is a top view of a display device according to Embodiment 1 of the present disclosure.

FIG. 2A to FIG. 2D are cross sectional views of display devices in some embodiments according to Embodiment 1 of the present disclosure.

FIG. 3A to FIG. 3B show top views and cross sectional views of a portion of a display device in some embodiment according to Embodiment 1 of the present disclosure.

FIG. 4 is another top view of a display device according to Embodiment 1 of the present disclosure.

FIG. 5A and FIG. 5B are schematic diagrams showing the driving of a display device at different frames in one embodiment according to Embodiment 1 of the present disclosure.

FIG. 6A and FIG. 6B are schematic diagrams showing the driving of a display device at different frames in another embodiment according to Embodiment 1 of the present disclosure.

FIG. 7 is a top view of a display device according to Embodiment 2 of the present disclosure.

FIG. 8 is a top view of a display device according to Embodiment 3 of the present disclosure.

FIG. 9 is a top view of a display device according to Embodiment 4 of the present disclosure.

FIG. 10 is a top view of a display device according to Embodiment 5 of the present disclosure.

### DETAILED DESCRIPTION OF EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

Furthermore, the terms recited in the specification and the claims such as “above”, “over”, or “on” are intended not only directly contact with the other element, but also intended indirectly contact with the other element. Similarly, the terms recited in the specification and the claims such as “below”, or “under” are intended not only directly contact with the other element but also intended indirectly contact with the other element.

Furthermore, the terms recited in the specification and the claims such as “connect” is intended not only directly connect with other element, but also intended indirectly connect and electrically connect with other element.

Furthermore, when a value is in a range from a first value to a second value, the value can be the first value, the second value, or another value between the first value and the second value.

In addition, the features in different embodiments of the present disclosure can be recombined with each other or match properly to form another embodiment.

### Embodiment 1

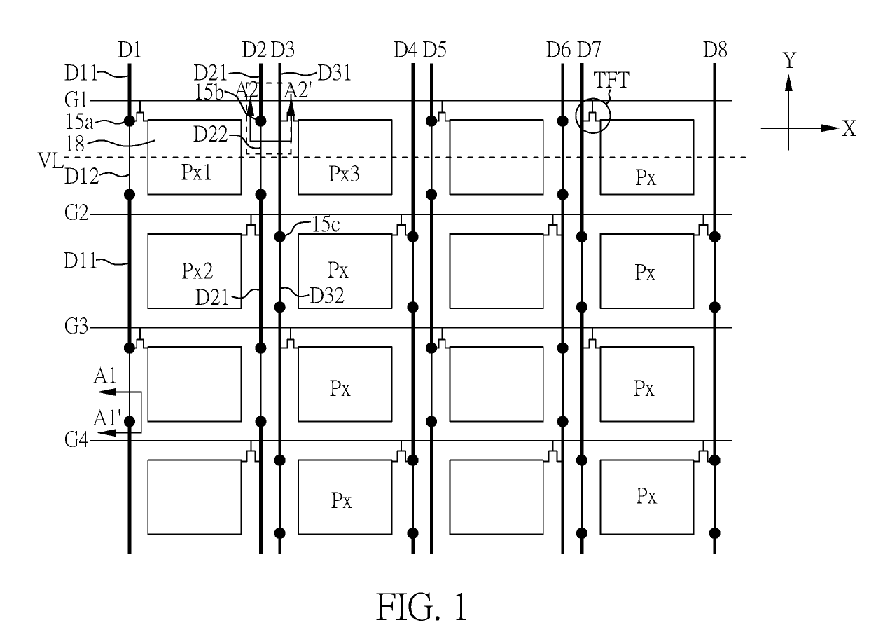

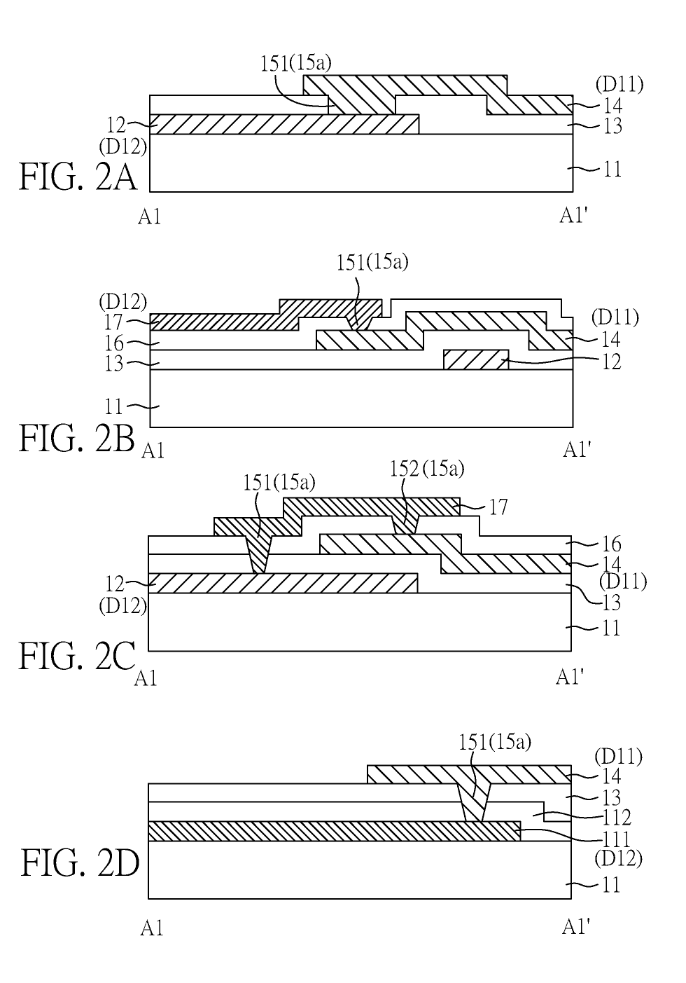

FIG. 1 is a top view of a display device of the embodiment, and FIG. 2A is a cross sectional view of a display device of the embodiment along the line A1-A1′ of FIG. 1. In some embodiments, the display device can be applied to a tiled device. The display device comprises: a substrate 11; a first pixel Px1 and a second pixel Px2 disposed on the substrate 11, wherein the first pixel Px1 and the second pixel Px2 are arranged along a first direction Y, and the first pixel Px1 is adjacent to the second pixel Px2, but it is not limited; and a first data line D1 and a second data line D2 disposed on the substrate 11, wherein the first data line D1 and the second data line D2 respectively extend along the first direction Y, and the first data line D1 and the second data line D2 may be arranged along a second direction X different from the first direction Y, but it is not limited. In the present disclosure, the term “second direction X” can be an extension direction of the first scan line G1, the scan line G2, the scan line G3 and/or the scan line G4. The term “first direction Y” can be an extension direction of the first data line D1, the second data line D2, the third data line D3, the data line D4, the data line D5, the data line D6, the data line D7 and/or the data line D8. In some embodiments, the first direction Y may be substantially perpendicular to the second direction X, and an angle included between the first direction Y and the second direction X can be in a range from 80 degrees to 90 degrees (80°≤θ≤90°), but it is not limited thereto. In some embodiment, the first direction Y is different from the second direction X, and an angle between the second direction X and the first direction Y is in a range between 45° to 90° (45°≤θ≤90°), but it is not limited.

The first pixel Px1 and the second pixel Px2 may be disposed between the first data line D1 and the second data line D2, the first data line D1 is electrically connected to the first pixel Px1, and the second data line D2 is electrically connected to the second pixel Px2. A first conductive portion D11 (indicated by the thick line) of the first data line D1 is electrically connected to a second conductive portion D12 (indicated by the thin line) of the first data line D1 through a first conductive via 15a (indicated by the dot), and a first conductive portion D21 (indicated by the thick line) of the second data line D2 is electrically connected to a second conductive portion D22 (indicated by the thin line) of the second data line D2 through a second conductive via 15b (indicated by the dot).

In addition, the display device further comprises a third pixel Px3 disposed on the substrate 11, wherein the first pixel Px1 and the third pixel Px3 are arranged along the second direction X, and the first pixel Px1 is disposed adjacent to the third pixel Px3, but it is not limited. A third data line D3 is disposed on the substrate 11, wherein the third data line D3 and the second data line D2 are arranged along the second direction X, the second data line D2 is disposed between the first data line D1 and the third data line D3, and the second data line D2 and the third data line D3 are disposed between the first pixel Px1 and the third pixel Px3. A first conductive portion D31 (indicated by the thick line) of the third data line D3 is electrically connected to a second conductive portion D32 (indicated by the thin line) of the third data line D3 through a third conductive via 15c (indicated by the dot). In addition, the third data line D3 extends along the first direction Y, and the first data line D1, the second data line D2 the third data line D3 are arranged along the second direction X, but it is not limited. Furthermore, the display device further comprises a first scan line G1 disposed on the substrate 11, the first scan line G1 is disposed adjacent to the first pixel Px1 and extends along the second direction X. The first scan line G1 crosses the first data line D1 and the second data line D2, and the first scan line G1 is electrically insulated from the first data line D1 and the second data line D2. In some embodiments, the first scan line G1 may be electrically connected to a gate electrode of a transistor TFT of the first pixel Px1, and the first data line D1 is electrically connected to a source electrode (or a drain electrode) of the transistor TFT of the first pixel Px1. In addition, the first pixel Px1, the second pixel Px2, the third pixel Px3 or other pixels may respectively have a pixel electrode 18. The pixel electrode 18 of the first pixel Px1 may be electrically connected to the first conductive portion D11 of the first data line D1, the pixel electrode 18 of the second pixel Px2 may be electrically connected to the first conductive portion D21 of the second data line D2, the pixel electrode 18 of the third pixel Px3 may be electrically connected to the first conductive portion D31 of the third data line D3, and/or the other pixels can be deduced by analogy. In some embodiments, the first conductive portion D11, the first conductive portion D21 and/or the first conductive portion D31 can be formed from the same conductive layer, and the conductive layer may form the source electrodes (or the drain electrodes) of the transistors TFT. In another embodiments, the first conductive portion D11, the first conductive portion D21 and/or the first conductive portion D31 may be electrically connected to the source electrodes (or the drain electrodes) of the transistors TFT through another conductive layer (not shown). In other pixels, the manner of the electrical connection relationship between the scan line, the data line, the transistor or the pixel electrode is similar to the first pixel Px1, and the descriptions are not repeated again.

As shown in FIG. 1, the display device may include one gate line/two data line (1G2D) display device. In other words, if the display device comprises N rows of pixels, and at least one of N rows may be arranged along the second direction X, the display device may comprise 2N data lines. For example, two sides of the pixels in one row respectively correspond to one data line, but it is not limited.

In the conventional display device, the data lines are made of same material. When the display device is an one gate line/two data line (1G2D) display device, two data lines may be disposed between two adjacent pixels (for example, the second data line D2 and the third data line D3 may be disposed between the first pixel Px1 and the third pixel Px3), a distance may be maintained between the second data line D2 and the third data line D3 to reduce the possibility of short circuit. For example, the second data line D2 and the third data line D3 may be electrically connected to each other, and the short circuit may be occurred. The distance may be maintained between the second data line D2 and the third data line D3 in the conventional display device, and the distance may be in a range from 5 μm to 10 μm (or greater than 10 μm). Thus, the aperture ratio of the pixel may be reduced in the conventional display device.

In some embodiments, two adjacent data lines disposed between two adjacent pixels may be designed to be formed by different conductive portions. For example, the second conductive portion D22 of the second data line D2 and the first conductive portion D31 of the third data line D3 are disposed between the first pixel Px1 and the third pixel Px3. The second conductive portion D22 of the second data line D2 and the first conductive portion D31 of the third data line D3 can be formed from different conductive layers. The conductive layer may include metal layer or transparent conductive layer, but it is not limited thereto. At least one dielectric layer (such as insulating layer) can be disposed between the second conductive portion D22 and the first conductive portion D31. The second conductive portion D22 and the first conductive portion D31 are close or overlapped with each other in a normal direction of the substrate 11, and the aperture ratio of the pixels can be increased. For example, the aperture ratios of the first pixel Px1 and/or the third pixel Px3 disposed adjacent to the second data line D2 and the third data line D3 can be increased.

As shown in FIG. 1, the first conductive portion D11 of the first data line D1 is electrically connected to the second conductive portion D12 of the first data line D1 through the first conductive via 15a, the first conductive portion D21 of the second data line D2 is electrically connected to the second conductive portion D22 of the second data line D2 through the second conductive via 15b, and the first conductive portion D31 of the third data line D3 is electrically connected to the second conductive portion D32 of the third data line D3 through the third conductive via 15c. The manner of the electrical connection relationship between the first conductive portion D11 and the second conductive portion D12 of the first data line D1 is described below. The manner of the electrical connection relationship between the first conductive portion D21 and the second conductive portion D22 of the second data line D2, or the manner of the electrical connection relationship between the first conductive portion D31 and the second conductive portion D32 of the third data line D3 is similar to the first data line D1, and is not repeated again.

As shown in FIG. 2A, a first conductive layer 12 may be disposed on (or formed on) the substrate 11, and a first dielectric layer 13 may be disposed on (or formed on) the first conductive layer 12. Then, a conductive via 151 may be formed in the first dielectric layer 13, the conductive via 151 is disposed corresponding to (or overlapped with) the first conductive layer 12, a second conductive layer 14 may be disposed on (or formed on) the first dielectric layer 13, and the second conductive layer 14 can electrically connect to the first conductive layer 12 through the conductive via 151. As shown in FIG. 1 and FIG. 2A, the first conductive layer 12 can form the first scan line G1 or other scan lines (for example, the scan line G2, the scan line G3 or the scan line G4, but it is not limited). In some embodiments, the first conductive layer 12 can form the second conductive portion D12 of the first data line D1, and the second conductive layer 14 can form the first conductive portion D11 of the first data line D1. In other words, the material of the second conductive portion D12 of the first data line D1 and the scan line can be the same, or the second conductive portion D12 of the first data line D1 and the scan line can be formed from the same conductive layer. The conductive via 151 can be can be regarded as the first conductive via 15a shown in FIG. 1, and the first conductive portion D11 formed from the second conductive layer 14 can electrically connect to the second conductive portion D12 formed from the first conductive layer 12 through the conductive via 151, but it is not limited.

Another embodiments shown in FIG. 2B is similar to the embodiment shown in FIG. 2A, except for the following differences. As shown in FIG. 2B, after forming the second conductive layer 14 on the first dielectric layer 13, a second dielectric layer 16 may be disposed (or formed). Then, the conductive via 151 may be formed in the second dielectric layer 16, the conductive via 151 may be formed corresponding to (or overlapped with) the second conductive layer 14, a third conductive layer 17 is formed on the second dielectric layer 16, the third conductive layer 17 is electrically connected to the second conductive layer 14 through the conductive via 151, and the first conductive layer 12 is not electrically connected to the second conductive layer 14. As shown in FIG. 1 and FIG. 2B, the first conductive layer 12 can form the first scan line G1 or other scan lines (for example, the scan line G2, the scan line G3 or the scan line G4, but is not limited). In some embodiments, the second conductive layer 14 can form the first conductive portion D11 of the first data line D1, and the third conductive layer 17 can form the second conductive portion D12 of the first data line D1. In other words, the martial of the first conductive portion D11 of the first data line D1 and the martial of the second conductive portion D12 of the first data line D1 may be different from the martial of the scan lines. In addition, the conductive via 151 can be regarded as the first conductive via 15a shown in FIG. 1, and the second conductive portion D12 formed from the third conductive layer 17 can be electrically connected to the first conductive portion D11 formed from the second conductive layer 14 through the conductive via 151. In some embodiments, the first conductive portion D11 can be disposed on the first conductive layer 12, the first dielectric layer 13 is disposed between the first conductive layer 12 and the first conductive portion D11, and the first conductive layer 12 may be electrically insulated with the first conductive portion D11, but it is not limited thereto.

Another embodiments shown in FIG. 2C is similar to the embodiment shown in FIG. 2B, except for the following differences. As shown in FIG. 2C, a conductive via 152 may be formed in the second dielectric layer 16, the conductive via 152 may be formed corresponding to (or overlapping with) the second conductive layer 14 formed on the second dielectric layer 16, a conductive via 151 may be formed in the first dielectric layer 13 and/or the second dielectric layer 16, and the conductive via 151 may be formed corresponding to (or overlapping with) the first conductive layer 12. The conductive via 151 formed in the first dielectric layer 13 and the second dielectric layer 16 can be formed by the same process (such as a photo process and/or an etch process). Then, a third conductive layer 17 may be disposed on the second dielectric layer 16 and disposed in (or filled in) the conductive via 151 and/or the conductive via 152, and the second conductive layer 14 is electrically connected to the first conductive layer 12 through the third conductive layer 17. As shown in FIG. 1 and FIG. 2C, the first conductive layer 12 can form the first scan line G1 or other scan lines (for example, the scan line G2, the scan line G3 or the scan line G4). The first conductive layer 12 can also form the second conductive portion D12 of the first data line D1. The second conductive layer 14 can form the first conductive portion D11 of the first data line D1. In other words, the material of the second conductive portion D12 of the first data line D1 may be same as the scan line. Furthermore, the first conductive portion D11 formed from the second conductive layer 14 can be electrically connected to the second conductive portion D12 formed from the first conductive layer 12 through the conductive via 151, the conductive via 152 and the third conductive layer 17, but it is not limited thereto.

As shown in FIG. 2D, in another embodiment, a fourth conductive layer 111 may be disposed on (or formed on) the substrate 11 in advance, and a dielectric layer 112 may be disposed on (or formed on) the fourth conductive layer 111. Then, a first conductive layer (not shown in FIG. 2D, but can refer to the first conductive layer 12 shown in FIG. 2A) may be disposed on (or formed on) the dielectric layer 112, and a first dielectric layer 13 may be disposed on (or formed on) the first conductive layer. A conductive via 151 may be formed in the dielectric layer 112 and/or the first dielectric layer 13, the conductive via 151 may be formed corresponding to (or overlapping with) the fourth conductive layer 111, and the conductive via 151 formed in the dielectric layer 112 and the first dielectric layer 13 can be formed by the same process (such as a photo process and/or an etch process), but it is not limited thereto. Then, a second conductive layer 14 may be formed on the first dielectric layer 13, and the second conductive layer 14 may be electrically connected to the fourth conductive layer 111 through the conductive via 151. As shown in FIG. 1 and FIG. 2D, the first conductive layer (not shown in FIG. 2D, but can refer to the first conductive layer 12 shown in FIG. 2A) can form the first scan line G1 or other scan lines (for example, the scan line G2, the scan line G3 or the scan line G4). In some embodiments, the fourth conductive layer 111 can form the second conductive portion D12 of the first data line D1, and the second conductive layer 14 can form the first conductive portion D11 of the first data line D1. In addition, the conductive via 151 can be regarded as the first conductive via 15a shown in FIG. 1, and the first conductive portion D11 formed from the second conductive layer 14 can be electrically connected to the second conductive portion D12 formed from the fourth conductive layer 111 through the conductive via 151, but it is not limited thereto.

FIG. 2A to FIG. 2D show the possible embodiments that the first conductive portion D11 and the second conductive portion D12 of the first data line D1 can be formed from different conductive layers, a dielectric layer is disposed between the first conductive portion D11 and the second conductive portion D12 of the first data line D1, and the manner to electrically connect the first conductive portion D11 and the second conductive portion D12. The manner of the electrical connection relationship between the first conductive portion D21 and the second conductive portion D22 of the second data line D2, or the manner of the electrical connection relationship between the first conductive portion D31 and the second conductive portion D32 of the third data line D3 can be similar to the embodiments shown in FIG. 2A to FIG. 2D, and is not repeated again. The manner to electrically connect different conductive layers is not limited to the embodiments shown in FIG. 2A to FIG. 2D. For example, other conductive material except for the material of the second conductive layer 14 or the material of the third conductive layer 17 can be disposed in (or filled in) the conductive via 151.

In some embodiments, the first scan line G1 crosses and is electrically insulated from the first conductive portion D11 of the first data line D1 and the first conductive portion D21 of the second data line D2. In other words, at least one dielectric layer may be disposed between the first scan line G1 and the first data line D1 and/or between the first scan line G1 and the second data line D2 and may correspond to the positions that the first scan line G1 crosses the first data line D1 and the second data line D2. Similarly, the first scan line G1 and other scan lines (for example, the scan line G2, the scan line G3 or the scan line G4) may be separated from (or be electrical insulated with) other data lines (for example, the data line D4, the data line D5, the data line D6, the data line D7 or the data line D8) by at least one dielectric layer, but it is not limited thereto.

As shown in FIG. 1, in some embodiments, the second conductive portion D22 of the second data line D2 may be disposed corresponding to the first pixel Px1, and the second conductive portion D12 of the first data line D1 may be disposed corresponding to the first pixel Px1. The first conductive portion D21 of the second data line D2 may be disposed corresponding to the second pixel Px2, and the first conductive portion D11 of the first data line D1 may be disposed corresponding to the second pixel Px2. The first conductive portion D31 of the third data line D3 may be disposed corresponding to the third pixel Px3. The second conductive portion D12 of the first data line D1 and the second conductive portion D22 of the second data line D2 may respectively disposed at two sides of the pixel electrode 18 of the first pixel Px1, the first conductive portion D11 of the first data line D1 and the first conductive portion D21 of the second data line D2 may be respectively disposed at two sides of the pixel electrode 18 of the second pixel Px2, and the first conductive portion D31 of the third data line D3 may be disposed at one side of the pixel electrode 18 of the third pixel Px3. The above conductive portions disposed at two sides of the pixel electrode 18 can be defined as follow: a virtual line VL is defined along a direction perpendicular to the data lines (for example, the first data line D1, the second data line D2 or the third data line D3), the virtual line VL may passes the central region of the pixel electrode 18 (for example, the center of the pixel electrode 18), and the conductive portions crossing the virtual line VL may be considered as the conductive portions disposed corresponding to at two sides of the pixel electrode 18.

As shown in FIG. 1, in the present embodiment, in the first direction Y, the first data line D1 can be formed by the first conductive portions D11 and the second conductive portions D12, the first conductive portions D11 are alternately arranged with and electrically connected to the second conductive portions D12. Similarly, the second data line D2 can be formed by the first conductive portions D21 and the second conductive portions D22, the first conductive portions D21 are alternately arranged with and electrically connected to the second conductive portions D22, the third data line D3 can be formed by the first conductive portions D31 and the second conductive portions D32, the first conductive portions D31 are alternately arranged with and electrically connected to the second conductive portions D32, and other data lines can be deduced by analogy. In some embodiments, the total amount of the first conductive portions of the first data line D1 and the total amount of the second conductive portions of the first data line D1 can be approximately the same as those of the second data line D2 (or those of the third data line D3), but it is not limited thereto. In another embodiment, the total length of the first conductive portions of the first data line D1 and the total length of the second conductive portions of the first data line D1 can be approximately the same as those of the second data line D2 or those of the third data line D3, but it is not limited thereto. When the total lengths of different conductive portions of different data lines are designed to be the same, or the total numbers of different conductive portions of different data lines are designed to be the same, a difference of the signal loading (for example, a different of resistive load) between the first data line D1, the second data line D2 and/or the third data line D3 can be reduced, the mura (or other abnormal image circumstance) caused from the difference of signal loading can be reduced.

In addition, as shown in FIG. 1, two data lines are disposed between two adjacent pixels, one of the two data lines disposed corresponding to the pixels may be designed as the second conductive portion, and another of the two data lines may be designed as the first conductive portion. For example, the second conductive portion D22 of the second data line D2 is disposed between the first pixel Px1 and the third pixel Px3 adjacent to the first pixel Px1 in the second direction X, and the first conductive portion D31 of the third data line D3 (i.e. another data line disposed between the first pixel Px1 and the third pixel Px3) may be disposed corresponding to the third pixel Px3. By the design illustrated above, the distance between two data lines disposed between two adjacent pixels can be reduced or the aperture ratio of the pixels can be increased.

In another embodiment, the conductive portions of the data lines disposed corresponding at two sides of one pixel can be formed from the same conductive layer. For example, the second conductive portion D12 and the second conductive portion D22 may be disposed corresponding at two sides of the pixel electrode 18 of the first pixel Px1. In this case, the coupling of the pixel electrode 18 and the conductive portions disposed corresponding at two sides of the pixel electrode 18 can be balanced or the cross-talk caused by the coupling difference can be reduced.

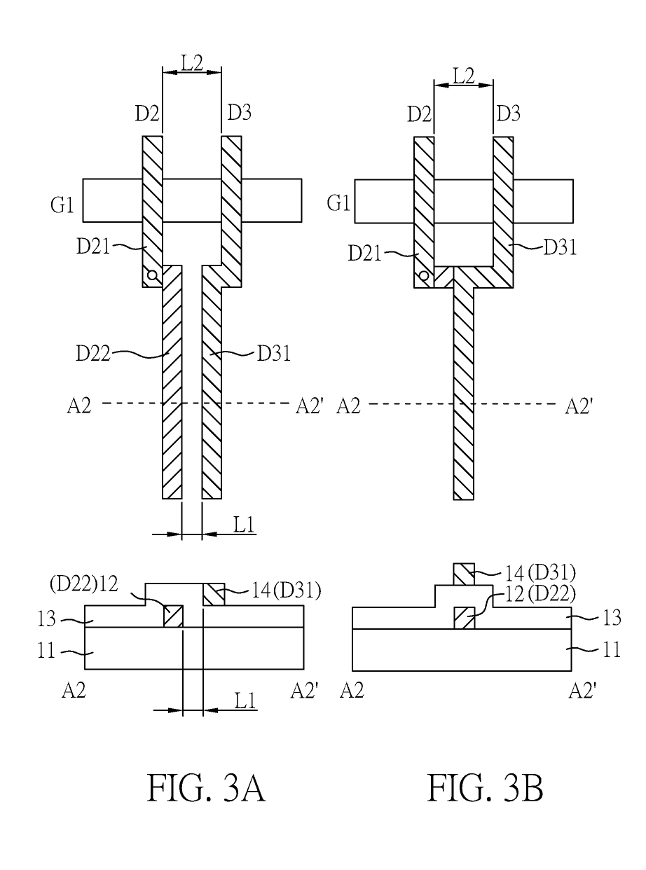

FIG. 3A and FIG. 3B show a portion (indicated by a dashed rectangle) of top views of FIG. 1 and a portion of cross sectional views along the line A2-A2′ of FIG. 1 in different embodiments. As shown in FIG. 3A, the second conductive portion D22 of the second data line D2 can be close to the first conductive portion D31 of the third data line D3. Alternatively, as shown in FIG. 3B, the second conductive portion D22 of the second data line D2 can be partially (or completely) overlapped with the first conductive portion D31 of the third data line D3. Because the first conductive portion and the second conductive portion are formed from different conductive layers, and a dielectric layer may be disposed to separate the first conductive portion and the second conductive portion (for example, the first dielectric layer 13, the second dielectric layer 16 and/or the dielectric layer 112 shown in FIG. 2A to FIG. 2D; or the first dielectric layer 13 shown in FIG. 3A and FIG. 3B), the possibility of short circuit caused by two data lines can be reduced when the two data lines between two pixels are close, even overlapped with each other. Therefore, the aperture ratios of the pixels can be increased.

In addition, as shown in FIG. 3A, a first distance L1 is between the second data line D2 disposed corresponding to the first pixel Px1 and the third data line D3 disposed corresponding to the third pixel Px3. As shown in FIG. 1 and FIG. 3A, the first distance L1 is between the second conductive portion D22 of the second data line D2 disposed corresponding to the pixel electrode 18 of the first pixel Px1 and the first conductive portion D31 of the third data line D3 disposed corresponding to the pixel electrode 18 of the third pixel Px3. A virtual line VL may be defined along a direction, which is approximately perpendicular to the data lines (for example, the second data line D2 or the third data line D3), and the conductive portions crossing the virtual line VL may be the conductive portions disposed corresponding to the pixel electrode. In addition, a second distance L2 is between the second data line D2 and the third data line D3 respectively crossing the first scan line G1. In some embodiments, the first distance L1 may be less than the second distance L2. In some embodiments, the first distance L1 may be in a range from 0 μm to 4 μm (0 μm≤L1≤4 μm). In another embodiments, the first distance L1 may be in a range from 0 μm to 1.5 μm (0 μm≤L1≤1.5 μm), but it is not limited thereto.

FIG. 3B shows the condition when the first distance L1 may be 0 μm, the second data line D2 disposed corresponding to the first pixel Px1 (for example, the second conductive portion D22) is overlapped with the third data line D3 disposed corresponding to the third pixel Px3 (for example, the first conductive portion D31) at a normal direction of the substrate 11. In some embodiments, the second distance L2 can be in a range from 5 μm to 10 μm (5 μm≤L2≤10 μm), but it is not limited thereto. In another embodiments, the second distance L2 can be in a range from 7 μm to 10 μm (7 μm≤L2≤10 μm). The above values of the second distance L2 are only illustrated for some embodiments, and the second distance L2 can be adjusted according to the resolution (or the aperture ratio) of the display device.

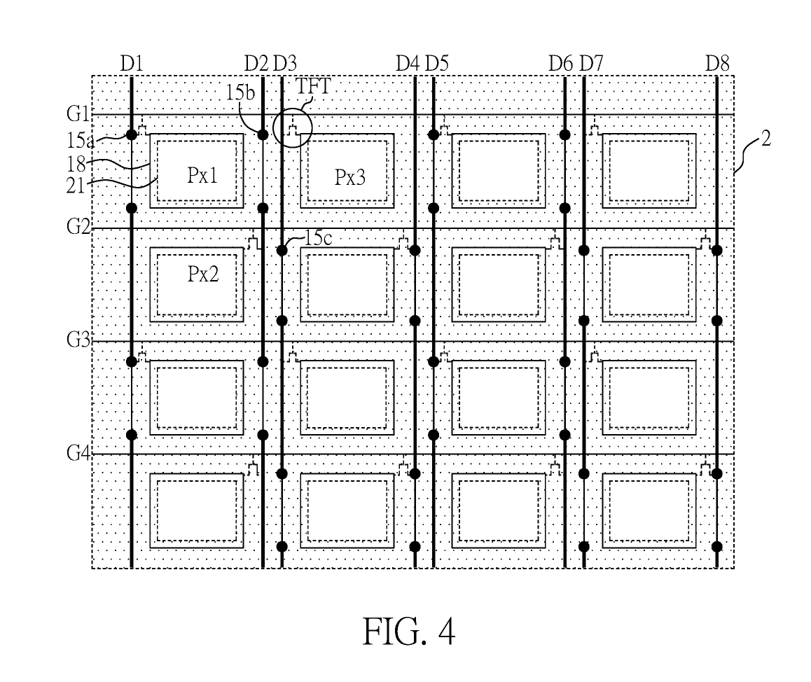

FIG. 4 is another top view of the display device of the embodiment. The display device comprises a shielding layer 2, the shielding layer 2 may comprise plural openings 21, and the shielding layer 2 may be disposed corresponding to (or be overlapped with) the first conductive via 15a, the second conductive via 15b, third conductive via 15c, other conductive vias, the first data line D1, the second data line D2, the third data line D3, the first scan line G1, the scan line G2, the scan line G3, the scan line G4, the data line D4, the data line D5, the data line D6, the data line D7, the data line D8 and/or the transistors TFT in the normal direction of the substrate 11. As shown in FIG. 4, the openings 21 may be disposed corresponding to the first pixel Px1, the second pixel Px2 and the third pixel Px3, and the openings 21 can be overlapped with the pixel electrodes 18 in the normal direction of the substrate 11. In some embodiments, a projection of the opening 21 on the substrate 11 can be the same as (or different from) a projection of the pixel electrodes 18 on the substrate 11, but it is not limited thereto. In some embodiments, the outlines of the opening 21 may be rectangles. In another embodiment, the outlines of the opening 21 may include polygon shape, curved shape or any other irregular shape, but it is not limited thereto. In some embodiments, the shielding layer 2 can be disposed on a counter substrate (not shown) opposite to the substrate 11. In another embodiment, the shielding layer 2 can be disposed on the substrate 11, but it is not limited thereto. The material of the shielding layer 2 can be black photoresist, black ink, black resin or any other suitable light shielding material, but it is not limited thereto.

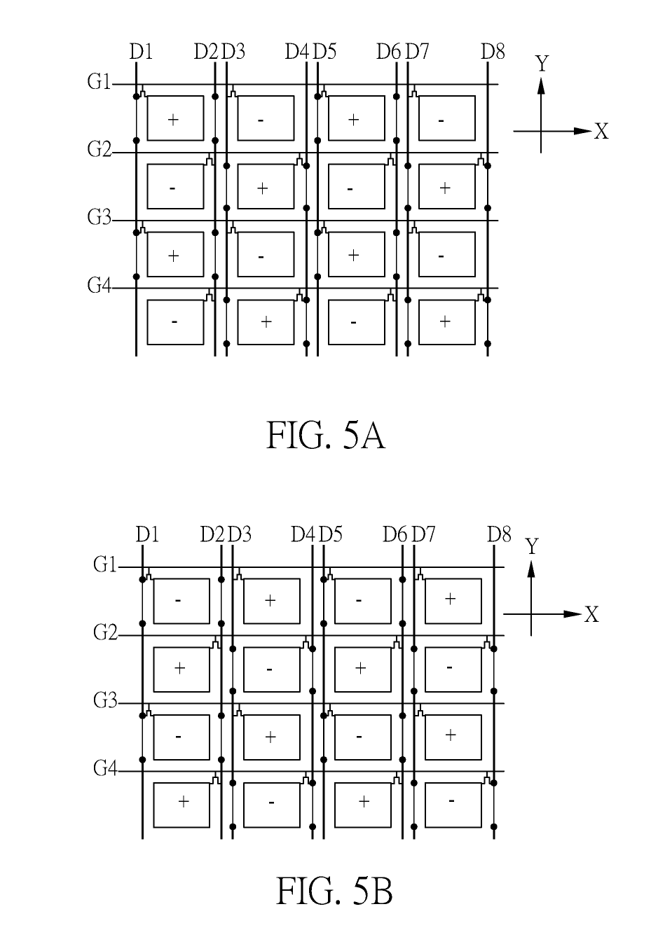

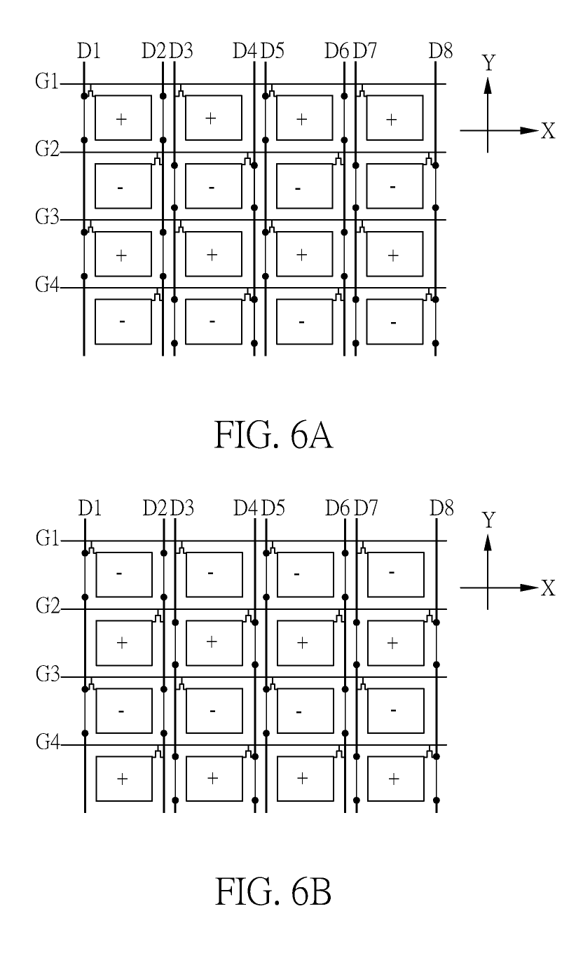

FIG. 5A and FIG. 5B are schematic diagrams showing the driving of the display device at different frames in one embodiment, FIG. 6A and FIG. 6B are schematic diagrams showing the driving of the display device at different frames in another embodiment. As shown in FIG. 5A, in the N frame, positive voltages can provide to the first data line D1, the data line D4, the data line D5 and the data line D8, and negative voltages can provide to the second data line D2, the third data line D3, the data line D6 and the data line D7. As shown in FIG. 5B, in the N+1 frame, negative voltages can provide to the first data line D1, the data line D4, the data line D5 and the data line D8, and positive voltages can provide to the second data line D2, the third data line D3, the data line D6 and the data line D7. Alternatively, as shown in FIG. 6A, in the N frame, positive voltages can provide to the first data line D1, the third data line D3, the data line D5 and the data line D7, and negative voltages can provide to the second data line D2, the data line D4, the data line D6 and data line D8. As shown in FIG. 6B, in the N+1 frame, negative voltages can provide to the first data line D1, the third data line D3, the data line D5 and the data line D7, and positive voltages can provide to the second data line D2, the data line D4, the data line D6 and data line D8. In other embodiments shown in FIG. 5A to FIG. 6B, positive and negative voltages are respectively provided to the two data lines disposed at two sides of the pixels. Thus, the cross-talk problem can be decreased by respectively providing positive and negative voltages to two data lines disposed at two sides of the pixels. FIG. 5A to FIG. 6B show some embodiments, but it is not limited thereto. In addition, the electrical connections of the transistors TFT and the data lines are also not limited thereto.

In the present embodiment, the substrate 11 may include a glass substrate, a sapphire substrate, a plastic substrate, a flexible circuit board, a rigid circuit board or other suitable material. The material of the substrate can include SiC, GaN, SiO₂, polyimide (PI), polyethylene terephthalate (PET), polycarbonate (PC), but it is not limited thereto. In some embodiments, the material of the first conductive layer 12, the second conductive layer 14, the third conductive layer 17 and/or the fourth conductive layer 111 can include transparent conductive material or metal, and metal can include Cu, Al, Mo, W, Au, Cr, Ni, Pt, It, other suitable metal, a combination thereof, or other conductive material with good conductivity or small resistance; but it is not limited thereto. The transparent conductive material can include ITO, IZO, ITZO, IGZO, or AZO; but it is not limited thereto. In some embodiments, the first conductive layer 12, the second conductive layer 14, the third conductive layer 17 and/or the fourth conductive layer 111 can be made by the same as or different conductive material.

The material of the first dielectric layer 13, the second dielectric layer 16 and/or the dielectric layer 112 can include resin, solder, silicon oxide, silicon nitride, silicon oxynitride, other suitable dielectric material or a combination thereof, but it is not limited thereto. The transistor TFT can include an amorphous silicon thin film transistor, a polysilicon thin film transistor, a low temperature polysilicon (LTPS) thin film transistor or an indium gallium zinc oxide (IGZO) thin film transistor, but it is not limited thereto. The material of the pixel electrode 18 may include ITO, ZnO:In (IZO), ZnO:Al (AZO) or IGZO, but it is not limited thereto.

### Embodiment 2

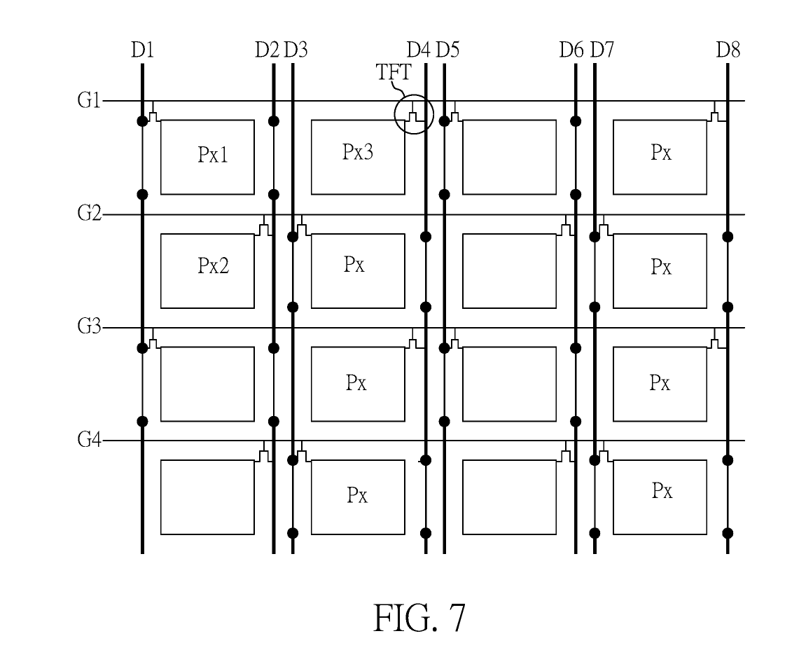

FIG. 7 is a top view of a display device of the present embodiment. The display device of the embodiment 2 is similar to the display device of the embodiment 1, except that the connection of the data lines to the transistors TFT corresponding to the third pixel Px3 and other pixels Px is different from that shown in the embodiment 1. More specifically, the connection of the transistors TFT of the pixels to the first data line D1, the second data line D2, the data line D5 and the data line D6 is similar to that shown in FIG. 1, and the connection of the transistors TFT of the pixels to the third data line D3, the data line D4, the data line D7 and data line D8 is different from that shown in FIG. 1.

For example, as shown in FIG. 1, the third data line D3 provides signal to the transistor TFT of the third pixel Px3. As shown in FIG. 7, the data line D4 provides signal to the transistor TFT of the third pixel Px3. In addition, as shown in FIG. 7, the transistors TFT electrically connected to the second data line D2 are mirrored to the transistors TFT electrically connected to the third data line D3. When the transistors TFT are arranged to be mirrored to each other, the area of the shielding layer (not shown in the figure) can be reduced.

### Embodiment 3

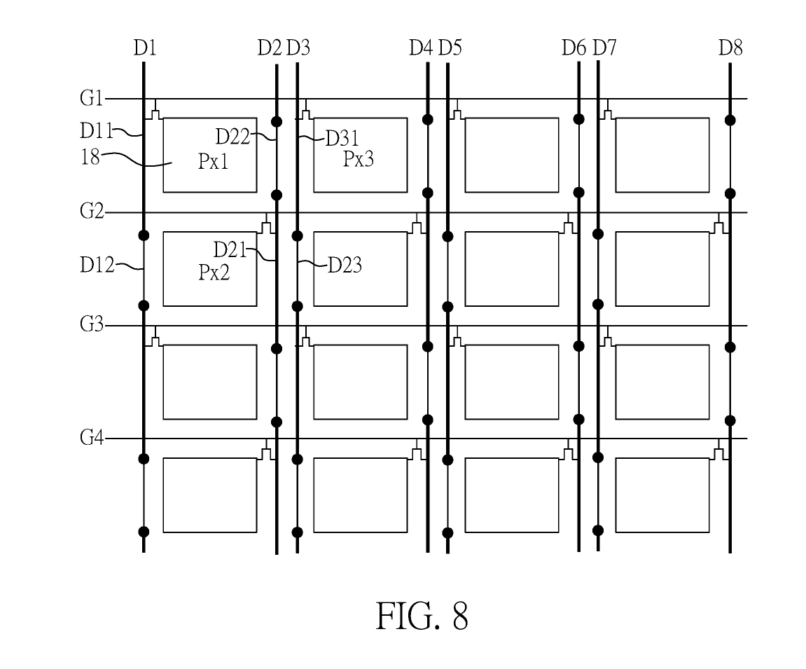

FIG. 8 is a top view of a display device of the present embodiment. The display device of the embodiments is similar to the display device shown in the embodiment 1, except for the following differences.

In the display device of the embodiment 3, the second conductive portion D22 of the second data line D2 may be disposed corresponding to the first pixel Px1, and the first conductive portion D11 of the first data line D1 may be disposed corresponding to the first pixel Px1. The first conductive portion D21 of the second data line D2 may be disposed corresponding to the second pixel Px2, and the second conductive portion D12 of the first data line D1 may be disposed corresponding to the second pixel Px2. The first conductive portion D31 of the third data line D3 may be disposed corresponding to the third pixel Px3. More specifically, the first conductive portion D11 of the first data line D1 and the second conductive portion D22 of the second data line D2 may be respectively disposed at two sides of the pixel electrode 18 of the first pixel Px1; the second conductive portion D12 of the first data line D1 and the first conductive portion D21 of the second data line D2 may be respectively disposed at two sides of the pixel electrode 18 of the second pixel Px2; and the first conductive portion D31 of the third data line D3 may be disposed at one side of the pixel electrode 18 of the third pixel Px3. In other word, two data lines are disposed at two sides of the pixel electrode 18 of one pixel, and the conductive portion of one of the data lines disposed corresponding to the pixel electrode 18 of the one pixel is different from the conductive portion of the other one of the data lines disposed corresponding to the pixel electrode 18 of the pixel.

### Embodiment 4

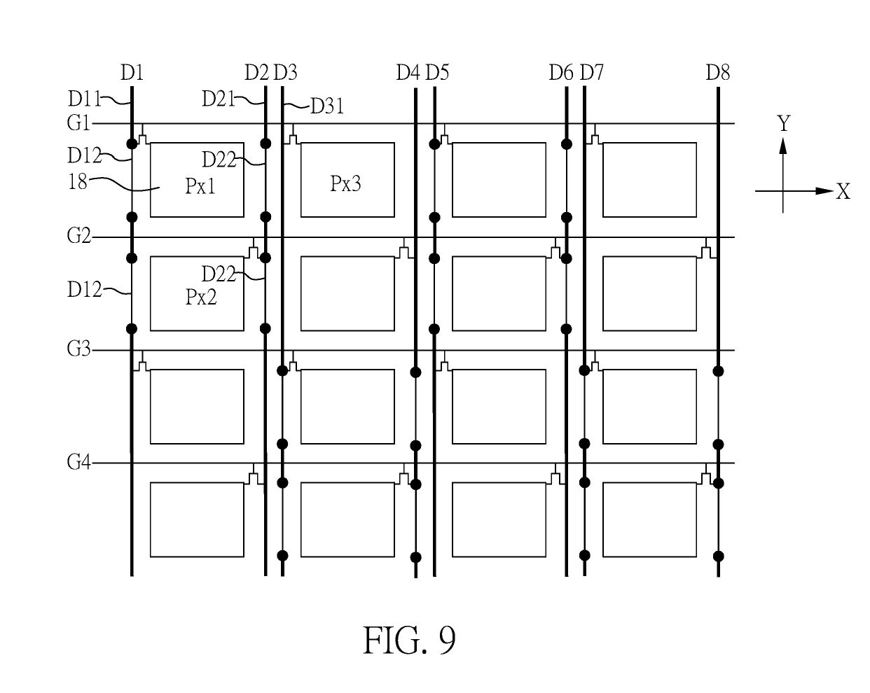

FIG. 9 is a top view of a display device of the present embodiment. The display device of the embodiment 4 is similar to the display device shown in the embodiment 1, except for the following differences.

In the embodiment 4, the second conductive portion D22 of the second data line D2 may be disposed corresponding to the first pixel Px1, and the second conductive portion D12 of the first data line D1 may be disposed corresponding to the first pixel Px1. The second conductive portion D22 of the second data line D2 may be disposed corresponding to the second pixel Px2, and the second conductive portion D12 of the first data line D1 is disposed corresponding to the second pixel Px2. The first conductive portion D31 of the third data line D3 may be disposed corresponding to the third pixel Px3. More specifically, the second conductive portion D12 of the first data line D1 and the second conductive portion D22 of the second data line D2 may be respectively disposed at two sides of the pixel electrode 18 of the first pixel Px1; the second conductive portion D12 of the first data line D1 and the second conductive portion D22 of the second data line D2 may be respectively disposed at two sides of the pixel electrode 18 of the second pixel Px2; and the first conductive portion D31 of the third data line D3 may be disposed at one side of the pixel electrode 18 of the third pixel Px3. In other words, among two adjacent pixels arranged along the first direction Y, one side (the same side) of the two adjacent pixels corresponds to the same conductive portions, which may be formed by the same conductive layer.

The above embodiments provide different implementations, and these embodiments can be combined in any combinations according to the needs.

In the aforesaid embodiment 1 to embodiment 4, one gate line/two data line (1G2D) display devices are described. For example, the structures shown in the embodiment 1 to the embodiment 4 can applied to two gate line/one data line (2G1D) display devices, when the first data line D1, the second data line D2 and the third data line D3 are considered as scan lines, the first scan line G1 is considered as a data line and the electrically connections of the transistor TFT are adjusted. Therefore, the structure of the 2G1D display device is not repeated again.

### Embodiment 5

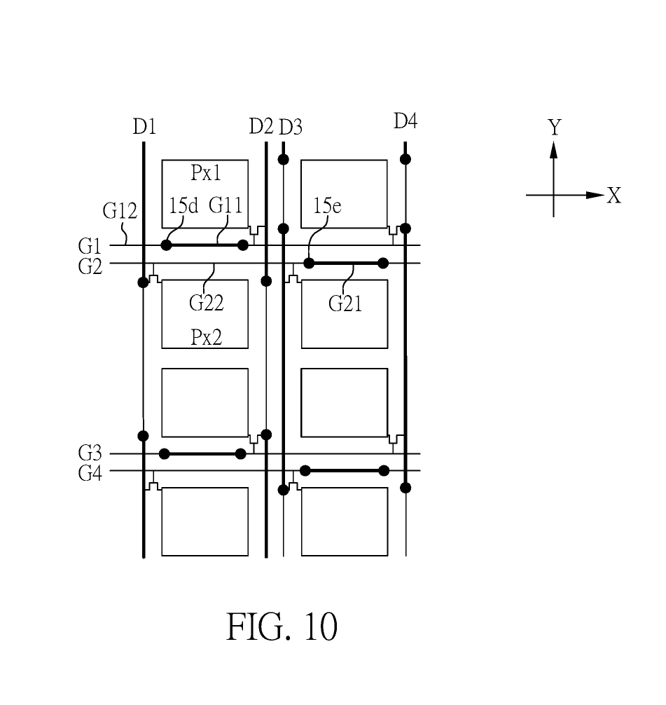

FIG. 10 is a top view of a display device of the present embodiment. The display device of the embodiment 5 is a two gate line/two data line (2G2D) display device. The differences between the embodiment 5 and the embodiments 1 to 4 are described below.

As shown in FIG. 10, as illustrated above, the first data line D1, the second data line D2 and the third data line D3 can respectively comprise the first conductive portions and the second conductive portions. In the embodiment 5, the first scan line G1 may also comprise a first conductive portion G11 (indicated by the thick line) and a second conductive portion G12 (indicated by the thin line), and the first conductive portion G11 may be electrically connected to the second conductive portion G12 through a fourth conductive via 15d (indicated by the thin line). Similarly, other scan lines (for example, the scan line G2, the scan line G3 and the scan line G4) may respectively comprise a first conductive portion (indicated by the thick line) and a second conductive portion (indicated by the thin line). For example, a first conductive portion G21 of the scan line G2 (indicated by the thick line) may be electrically connected to a second conductive portion G22 of the scan line G2 (indicated by the thin line) through a fourth conductive via 15e.

In the embodiment 5, the first pixel Px1 and the second pixel Px2 may be arranged along the first direction Y, and the first scan line G1 and the scan line G2 may be arranged along the first direction Y; but the first scan line G1 and the scan line G2 are disposed between the first pixel Px1 and the second pixel Px2. In some embodiments, the gate electrodes of the transistors TFT of the first pixel Px1 and the second pixel Px2 may be respectively electrically connecting to the second conductive portion G12 of the first scan line G1 and the second conductive portion G22 of the second scan line G2, and the second conductive portion G12 and the second conductive portion G22 can be formed from the same conductive layer. The arrangements (or the advantages) of the first scan line G1 and the scan line G2 respectively comprising the first conductive portions and the second conductive portions are similar to those stated above, and are not repeated again. It should be noted that, the data lines and the scan lines have to be formed from different conductive layers at the interlaced position of the data lines and the scan lines. In other words, at least one dielectric layer may be disposed between the data lines and the scan lines at the interlaced position to electrically insulate the data lines and the scan lines.

The display device may comprise liquid crystals (LCs), organic light-emitting diodes (OLEDs), quantum dots (QDs), fluorescence, phosphors, light-emitting diodes (LEDs), micro-LEDs, mini-LEDs quantum dots light-emitting diodes (QLED or QD-LED), but it is not limited thereto.

The display device may include a touch panel to form a touch display device. A display device may be applied as a flexible or curved display device.

Although the present disclosure has been explained in relation to its embodiment, it is to be understood that many other possible modifications and variations can be made without departing from the spirit and scope of the disclosure as hereinafter claimed.

What is claimed is:

1. A display device, comprising:
a substrate;
a first pixel and a second pixel disposed on the substrate, wherein the first pixel and the second pixel are arranged along a first direction; and
a first data line and a second data line disposed on the substrate, wherein the first data line and the second data line are arranged along a second direction, the first pixel and the second pixel are disposed between the first data line and the second data line, and the first direction is different from the second direction,
wherein the first data line is electrically connected to the first pixel, the second data line is electrically connected to the second pixel, a first conductive portion of the first data line is electrically connected to a second conductive portion of the first data line through a first conductive via, and a first conductive portion of the second data line is electrically connected to a second conductive portion of the second data line through a second conductive via.

2. The display device of claim 1, further comprising:
a third pixel disposed on the substrate, wherein the first pixel and the third pixel are arranged along the second direction; and
a third data line disposed on the substrate, wherein the third data line and the second data line are arranged along the second direction, the second data line is disposed between the first data line and the third data line, and the second data line and the third data line are disposed between the first pixel and the third pixel,
wherein a first conductive portion of the third data line is electrically connected to a second conductive portion of the third data line through a third conductive via, the second conductive portion of the second data line is disposed corresponding to the first pixel, and the first conductive portion of the third data line is disposed corresponding to the third pixel.

3. The display device of claim 2, wherein the first pixel is disposed adjacent to the third pixel, and the second data line disposed corresponding to the first pixel overlaps with the third data line disposed corresponding to the third pixel.

4. The display device of claim 2, wherein the second conductive portion of the second data line disposed corresponding to the first pixel overlaps with the first conductive portion of the third data line disposed corresponding to the third pixel.

5. The display device of claim 1, wherein the first conductive portion of the first data line and the second conductive portion of the first data line are formed from different conductive layers.

6. The display device of claim 1, wherein the second conductive portion of the first data line is disposed corresponding to the first pixel.

7. The display device of claim 1, wherein the first conductive portion of the first data line is disposed corresponding to the first pixel.

8. The display device of claim 1, wherein the second conductive portion of the second data line is disposed corresponding to the second pixel.

9. The display device of claim 1, wherein the first conductive portion of the second data line is disposed corresponding to the second pixel.

10. The display device of claim 1, wherein the second conductive portion of the first data line is disposed corresponding to the second pixel.

11. The display device of claim 1, wherein the first conductive portion of the first data line is disposed corresponding to the second pixel.

12. The display device of claim 2, further comprising:
a first scan line disposed on the substrate, wherein the first scan line is disposed adjacent to the first pixel and extends along the second direction, and the first scan line crosses and is electrically insulated from the first data line and the second data line,
wherein a first distance is between the second conductive portion of the second data line disposed corresponding to the first pixel and the first conductive portion of the third data line disposed corresponding to the third pixel, a second distance is between the second data line and the third data line respectively crossing the first scan line, and the first distance is less than the second distance.

13. The display device of claim 12, wherein the first distance is in a range from 0 μm to 4 μm.

14. The display device of claim 12, wherein the second distance is in a range from 5 μm to 10 μm.

15. The display device of claim 1, further comprising a shielding layer is disposed corresponding to the first data line, the second data line, the first conductive via and the second conductive via.

16. The display device of claim 1, further comprising a shielding layer overlapped with the first data line, the second data line, the first conductive via and the second conductive via.

17. The display device of claim 1, further comprising a dielectric layer disposed between the first conductive portion of the first data line and the second conductive portion of the first data line.

18. The display device of claim 1, further comprising a dielectric layer disposed between the first conductive portion of the second data line and the second conductive portion of the second data line.

19. A display device, comprising:
a substrate;
a first pixel and a second pixel disposed on the substrate, wherein the first pixel and the second pixel are arranged along a first direction; and
a first scan line and a second scan line disposed on the substrate, wherein the first scan line and the second scan line are arranged along the first direction,
wherein the first scan line is electrically connected to the first pixel, the second scan line is electrically connected to the second pixel, and a first conductive portion of the first scan line is electrically connected to a second conductive portion of the first scan line through a conductive via.

20. The display device of claim 19, wherein a second conductive portion of the second scan line is electrically connected to a first conductive portion of the second scan line through a conductive via.
